(19) United States
(12) Patent Application Publication
(10) Pub. No.: US 2023/0405755 A1
(43) Pub. Date: Dec. 21, 2023

(54) GRINDING APPARATUS

(71) Applicant: DISCO CORPORATION, Tokyo (JP)

(72) Inventor: Yuto MAEDA, Tokyo (JP)

(21) Appl. No.: 18/328,978

(22) Filed: Jun. 5, 2023

(30) Foreign Application Priority Data
Jun. 20, 2022 (JP) 2022-098584

(51) Int. Cl. B24B 7/07

(52) U.S. Cl. CPC B24B 7/07

(57) ABSTRACT

There is provided a grinding apparatus used at the time of grinding a workpiece. The grinding apparatus includes a chuck table that has a holding surface for holding the workpiece, a grinding unit that has a spindle to which a grinding wheel in which a plurality of grindstones are arrayed in an annular shape is mounted, and an exterior cover that includes an opening facing the grinding unit and a door capable of covering the opening and that covers both the chuck table and the grinding unit. In the grinding apparatus, on an inner surface of the door that faces the grinding unit in a closed state in which the opening is covered by the door, a work bench that is folded to prevent interference with the grinding unit in the closed state is provided.

### BACKGROUND OF THE INVENTION

### Field of the Invention

The present invention relates to a grinding apparatus that is used at the time of grinding a plate-shaped workpiece such as a wafer.

### Description of the Related Art

At the time of grinding a plate-shaped workpiece such as a wafer, a grinding apparatus including a chuck table that has a holding surface capable of holding the workpiece and a grinding unit that has a spindle to which a grinding wheel having a plurality of grindstones arrayed is mounted by a bolt or the like is used (see, for example, Japanese Patent Laid-open No. 2003-181767). The grinding unit is supported by a grinding feed mechanism of a ball-screw system. When the grinding feed mechanism moves the grinding wheel in a direction that intersects the holding surface and causes the grindstones to come into contact with the workpiece on the chuck table, the workpiece is ground.

In the grinding apparatus as described above, the thickness of the ground workpiece is controlled with high accuracy, by setting the position where the grindstones of the grinding wheel come into contact with the holding surface of the chuck table to a reference position of the grinding feed mechanism. Setting the reference position in the grinding apparatus is performed by such a method that an operator causes the grindstones to approach the chuck table in a state in which gauge blocks of a predetermined thickness are disposed on the chuck table. Note that, since this reference position shifts by attachment and detachment of the grinding wheel, the reference position is set every time the grinding wheel is replaced.

### SUMMARY OF THE INVENTION

Incidentally, maintenance work for a grinding apparatus as typified by the replacement of the grinding wheel requires a plurality of tools, such as a replacement tool including a torque wrench, cleaning tools including cloth and alcohol, and the abovementioned gauge blocks which are tools for setting reference positions. As such, at the time of performing maintenance work for the grinding apparatus, a work bench on which these tools can be placed is used.

However, carrying in the work bench and making preparations or performing cleaning therefor, for example, every time maintenance work for the grinding apparatus is performed results in low working efficiency. Moreover, there is also a need to separately reserve a place for storing the work bench after its use, at a place that is not so far from the place where the grinding apparatus is installed.

It is accordingly an object of the present invention to provide a grinding apparatus that is advantageous in terms of space-saving and is also capable of increasing efficiency of work related to maintenance of the grinding apparatus.

In accordance with an aspect of the present invention, there is provided a grinding apparatus used at a time of grinding a workpiece, the grinding apparatus including a chuck table that has a holding surface for holding the workpiece, a grinding unit that has a spindle to which a grinding wheel in which a plurality of grindstones are arrayed in an annular shape is mounted, and an exterior cover that includes an opening facing the grinding unit and a door capable of covering the opening and that covers both the chuck table and the grinding unit. In the grinding apparatus, on an inner surface of the door that faces the grinding unit in a closed state in which the opening is covered by the door, a work bench that is folded to prevent interference with the grinding unit in the closed state is provided.

Preferably, on the inner surface of the door, a shelf on which a case that houses the grinding wheel is placed is further provided.

The grinding apparatus according to the aspect of the present invention includes a work bench that is folded to prevent interference with the grinding unit, on the inner surface of the door that covers the opening of the exterior cover. Accordingly, there is no need to carry in the work bench and make preparations or perform cleaning therefor, every time maintenance work for the grinding apparatus that is performed in a state in which the opening is exposed is performed. Moreover, in the closed state in which the opening is covered by the door, the work bench is housed in the inner side of the exterior cover, so that there is no need to reserve a place for storing the work bench separately from a place where the grinding apparatus is installed.

As described above, according to the aspect of the present invention, a grinding apparatus that is advantageous in terms of space-saving and is also capable of increasing the efficiency of the work related to maintenance of the grinding apparatus is provided.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view schematically illustrating a structure of a grinding apparatus according to an embodiment of the present invention;

FIG. 2 is a perspective view schematically illustrating an exterior of the grinding apparatus;

FIG. 3 is a perspective view schematically illustrating the grinding apparatus in a state in which a door is opened;

FIG. 4 is a front view of the door, a work bench, and a shelf as viewed from the inside of the door; and

FIG. 5 is a side elevational view of the door, the work bench, and the shelf.

### DETAILED DESCRIPTION OF THE PREFERRED EMBODIMENT

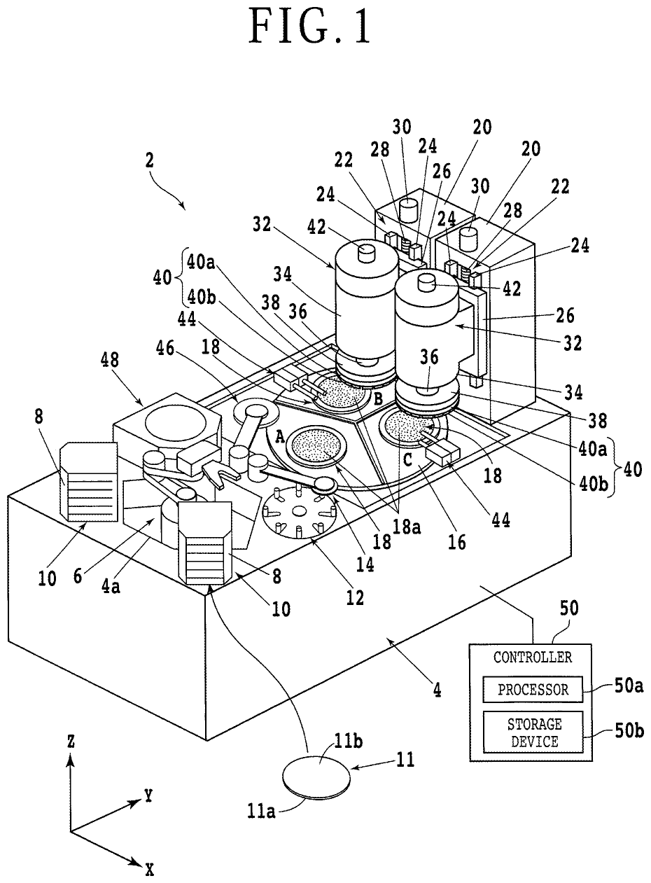

An embodiment of the present invention will be described below with reference to the attached drawings. FIG. 1 is a perspective view schematically illustrating a structure of a grinding apparatus 2 according to the present embodiment. Note that, in FIG. 1, some components configuring the grinding apparatus 2 are represented by functional blocks. Further, an X-axis (an axis along the left-right direction), a Y-axis (an axis along the forward-rearward direction), and a Z-axis (an axis along the upward-downward direction) that are used in the following description are perpendicular with one another.

As illustrated in FIG. 1, the grinding apparatus 2 includes a base 4 that supports various components configuring the grinding apparatus 2. On a front end side on an upper surface of the base 4, there is provided a recessed housing portion 4a which has an upper end opened in the upper surface of the base 4. The housing portion 4a houses therein a first delivery mechanism 6 that is used for delivering a plate-shaped workpiece 11. The first delivery mechanism 6 is typically a robot arm that has a plurality of joints. The first delivery mechanism 6 can not only deliver the workpiece 11 but also turn the workpiece 11 upside down.

The workpiece 11 is, for example, a disc-shaped wafer including a semiconductor material such as silicon. Specifically, the workpiece 11 has a circular face side 11a and a circular reverse side 11b that is on an opposite side of the face side 11a. The face side 11a of the workpiece 11 is, for example, partitioned into a plurality of small areas by a plurality of streets (projected dicing lines) in crisscross relation. In the small areas, devices such as integrated circuits (ICs) are formed.

The grinding apparatus 2 according to the present embodiment is, for example, used at the time when the reverse side 11b of the workpiece 11 is ground. Note that, when the reverse side 11b of the workpiece 11 is to be ground, a protective member composed of such a material as resin is preferably affixed to the face side 11a of the workpiece 11. With the protective member affixed to the face side 11a of the workpiece 11, impact that would be caused to the face side 11a when the reverse side 11b is ground is reduced, protecting the devices and the like formed in the workpiece 11.

In the present embodiment, a disc-shaped wafer including a semiconductor material such as silicon is used as the workpiece 11, but the material, shape, structure, size, and the like of the workpiece 11 are not limited to the abovementioned forms. For example, a substrate or the like including such a material as other semiconductors, ceramic, resin, or metal can be used as the workpiece 11. Similarly, the type, number, shape, structure, size, arrangement, and the like of the devices are not limited to the abovementioned forms. The devices may not be formed in the workpiece 11.

As illustrated in FIG. 1, on a front side of the housing portion 4a, there are provided two cassette placement regions 10 on which cassettes 8 capable of housing a plurality of workpieces 11 are mounted. On an obliquely rear side of the housing portion 4a, a position adjustment mechanism 12 used for adjusting the position of the workpiece 11 is provided. The position adjustment mechanism 12 has a disc-shaped position adjustment table smaller in diameter than the workpiece 11 and a plurality of pins arranged around the position adjustment table.

When the plurality of pins are moved along a radial direction of the position adjustment table, for example, the center of the workpiece 11 that has been unloaded from the cassette 8 by the first delivery mechanism 6 and that is placed on the position adjustment table is adjusted to a predetermined position in a direction along the X-axis and a direction along the Y-axis. Note that the workpiece 11 is placed on the position adjustment table in such a manner that its to-be-ground surface (reverse side 11b in the present embodiment) is exposed upward.

On a lateral side of the position adjustment mechanism 12, there is provided a second delivery mechanism 14 that holds the workpiece 11 and delivers it toward the rear. The second delivery mechanism 14 includes, for example, an arm and a holding pad that is connected to a distal end portion of the arm and that is capable of holding under suction an upper surface (to-be-ground surface) of the workpiece 11. The second delivery mechanism 14 swings the holding pad by the arm to thereby deliver toward the rear the workpiece 11 whose position has been adjusted by the position adjustment mechanism 12.

In the rear of the second delivery mechanism 14, a turntable 16 is provided. The turntable 16 is connected to a rotary drive source (not illustrated), such as a motor, and rotates about a rotational axis that is substantially parallel to the Z-axis, by power generated by the rotary drive source. On an upper surface of the turntable 16, three sets of disc-shaped chuck tables 18 are provided at substantially equal angular intervals along a circumferential direction of the turntable 16. Yet, the number, manner of arrangement, and the like of the chuck tables 18 are not limited to the abovementioned forms.

Each chuck table 18 includes, for example, a disc-shaped frame body including such a material as ceramic. On an upper portion of the frame body, a recessed portion which has an upper end opened in a circular shape on an upper surface of the frame body is provided. To this recessed portion, a porous holding plate configured to have a disc shape with such a material as ceramic is fixed.

An upper surface (holding surface) 18a of the holding plate is, for example, configured to have a shape corresponding to a conical surface and functions as a holding surface for holding the workpiece 11. Note that the difference in height (height difference) between a center of the upper surface 18a of the holding plate that corresponds to a vertex of a cone and an outer peripheral edge of the upper surface 18a of the holding plate is approximately 10 μm to 30 μm.

A lower surface side of the holding plate is connected to a suction source such as an ejector through a suction channel provided inside the frame body, a valve disposed outside of the frame body, and the like. Accordingly, when the valve is opened and negative pressure generated at the suction source is caused to act in a state in which the workpiece 11 and the like are in contact with the upper surface 18a of the holding plate, the workpiece 11 is sucked by the chuck table 18. That is, the workpiece 11 is held by the holding surface of the chuck table 18.

Each chuck table 18 is connected to a rotary drive source (not illustrated) such as a motor, and rotates about a rotational axis that is substantially parallel to the Z-axis or that is slightly inclined with respect to the Z-axis, by power generated by the rotary drive source. Note that each chuck table 18 is supported by the turntable 16 via an angle adjustment mechanism (not illustrated), and the angle of the rotational axis of each chuck table 18 is adjusted by the angle adjustment mechanism.

By rotation of the turntable 16, each chuck table 18 moves, for example, to a loading/unloading area A adjacent to the second delivery mechanism 14, a coarse grinding area B in the rear of the loading/unloading area A, a finish grinding area C on a lateral side of the coarse grinding area B, and the loading/unloading area A, in this order. The second delivery mechanism 14 delivers the workpiece 11 held by the holding pad, from the position adjustment table of the position adjustment mechanism 12 to the chuck table 18 positioned to the loading/unloading area A.

As illustrated in FIG. 1, in the rear of the coarse grinding area B and the finish grinding area C (that is, in the rear of the turntable 16), respective columnar support structures 20 are provided. On a front side of the support structures 20, Z-axis movement mechanisms 22 are provided. Each Z-axis movement mechanism 22 includes a pair of guide rails 24 that are substantially parallel to the Z-axis and have a moving plate 26 mounted thereon in a slidable manner.

On a rear surface side (reverse side) of each moving plate 26, a nut portion (not illustrated) configuring a ball screw is provided. To this nut portion, a screw shaft 28 that is substantially parallel to the guide rails 24 is coupled in such a manner that the screw shaft 28 can rotate. One end portion of each screw shaft 28 is connected to a rotary drive source 30 such as a motor. When the screw shaft 28 is rotated by the rotary drive source 30, the moving plate 26 moves along the guide rails 24.

On a front surface (face side) of each moving plate 26, a grinding unit 32 is supported. Each grinding unit 32 includes a spindle housing 34 fixed to the moving plate 26. In each spindle housing 34, a spindle 36 which has a rotational axis parallel to the Z-axis or an axial center that is slightly inclined with respect to the Z-axis is housed in such a manner as to be rotatable about the axial center.

A lower end portion of each spindle 36 is exposed from a lower end surface of the spindle housing 34 and has a disc-shaped mount 38 fixed thereto. For example, to an outer edge portion of each mount 38, a plurality of holes (not illustrated) that penetrate the mount 38 in a thickness direction are provided, and into each hole, a bolt (not illustrated) which is a fixing tool is inserted.

To a lower surface of the mount 38 of the grinding unit 32 that is on the coarse grinding area B side, a grinding wheel 40 for coarse grinding is attached by a bolt. Specifically, to the spindle 36 on the coarse grinding area B side, the grinding wheel 40 for coarse grinding is mounted. Moreover, to an upper portion of the spindle housing 34 of the grinding unit 32 on the coarse grinding area B side, a rotary drive source 42, such as a motor, that is connected to an upper end side of the spindle 36 is provided. By power generated by the rotary drive source 42, the grinding wheel 40 for coarse grinding rotates together with the spindle 36.

Meanwhile, to a lower surface of the mount 38 of the grinding unit 32 on the finish grinding area C side, a grinding wheel 40 for finish grinding is attached by a bolt. Specifically, to the spindle 36 on the finish grinding area C side, the grinding wheel 40 for finish grinding is mounted. Moreover, to an upper portion of the spindle housing 34 of the grinding unit 32 on the finish grinding area C side, a rotary drive source 42, such a motor, that is connected to the upper end side of the spindle 36 is provided. By power generated by the rotary drive source 42, the grinding wheel 40 for finish grinding rotates together with the spindle 36.

Each of the grinding wheels 40 includes an annular wheel base 40a that is formed with such metal as stainless steel or aluminum. On a lower surface of the wheel base 40a, a plurality of grindstones 40b formed by abrasive grains such as diamonds being dispersed in such bonding agents as a vitrified bond or a resinoid bond are arrayed annularly along a circumferential direction of the wheel base 40a.

Note that the average grain size of the abrasive grains included in the grindstones 40b of the grinding wheel 40 for finish grinding is smaller than the average grain size of the abrasive grains included in the grindstones 40b of the grinding wheel 40 for coarse grinding. This implements the grinding wheel 40 suitable for coarse grinding and the grinding wheel 40 suitable for finish grinding. The specific grain size of the abrasive grains is set as appropriate according to the quality or the like required of the post-grinding workpiece 11.

On the side of each of the grinding wheels 40, there is provided a nozzle (not illustrated) that is capable of supplying liquid (grinding liquid) such as purified water to a portion where the workpiece 11 held on the chuck table 18 comes into contact with the grindstones 40b. Note that, in place of or together with the nozzle, a liquid supply port used for supplying liquid may be provided to the grinding wheel 40 or the like.

On a lateral side of each of the coarse grinding area B and the finish grinding area C, a thickness measurement unit 44 used for measuring the thickness or the like of the workpiece 11 that is being ground is provided. The thickness measurement unit 44 typically includes a first height gauge that is capable of measuring the height of the upper surface of the frame body of the chuck table 18 and a second height gauge that is capable of measuring the height of the upper surface of the workpiece 11 held on the chuck table 18. A difference between the measurement value obtained by the first height gauge and the measurement value obtained by the second height gauge is employed as the thickness of the workpiece 11.

The workpiece 11 held on the chuck table 18 in the coarse grinding area B is ground on the upper surface side by the grinding unit 32 on the coarse grinding area B side described above. Further, the workpiece 11 held on the chuck table 18 in the finish grinding area C is ground on the upper surface side by the grinding unit 32 on the finish grinding area C side described above.

Specifically, with the chuck table 18 holding the workpiece 11 moving to the loading/unloading area A, the coarse grinding area B, and the finish grinding area C in this order, coarse grinding of the workpiece 11 and finish grinding of the workpiece 11 performed after the coarse grinding are successively performed. After finish grinding of the workpiece 11 is ended, the chuck table 18 in the finish grinding area C is positioned to the loading/unloading area A again.

At the position on the front side of the loading/unloading area A and on the lateral side of the second delivery mechanism 14, a third delivery mechanism 46 for holding the workpiece 11 that has been ground and delivering it toward the front side is provided. The third delivery mechanism 46 includes a holding pad for holding under suction the upper surface side of the workpiece 11 and an arm connected to this holding pad. The third delivery mechanism 46 swings the holding pad by the arm to thereby deliver the workpiece 11 that has been ground, from the chuck table 18 in the loading/unloading area A toward the front side.

On a lateral side of the third delivery mechanism 46, a cleaning unit 48 for cleaning the workpiece 11 that has been unloaded by the third delivery mechanism 46 is provided. The cleaning unit 48 includes, for example, a spinner table that rotates in a state of holding the lower surface side of the workpiece 11 and a cleaning nozzle that jets cleaning fluid to the upper surface side of the workpiece 11 held by the spinner table.

The cleaning fluid used by the cleaning unit 48 is typically a mixed fluid (binary fluid) in which water and air are mixed. Needless to say, water not mixed with air, for example, may be used as the cleaning fluid. The workpiece 11 cleaned by the cleaning unit 48 is delivered by the first delivery mechanism 6 and housed in the cassette 8 as the delivery source, for example.

The components of the grinding apparatus 2 are connected to the controller 50. The controller 50 includes, for example, a computer including a processor and a storage device 50b. The controller 50 controls, for example, the operations of the components of the grinding apparatus 2 described above, in such a manner that the workpiece 11 is ground appropriately.

The processor 50a is typically a central processing unit (CPU) and performs various kinds of processing necessary for controlling the components described above. The storage device 50b includes, for example, a main storage device such as a dynamic random access memory (DRAM) and an auxiliary storage device such a hard disk drive and a flash memory. The function of the controller 50 is implemented by the processor 50a operating in accordance with software such as a program stored in the storage device 50b, for example.

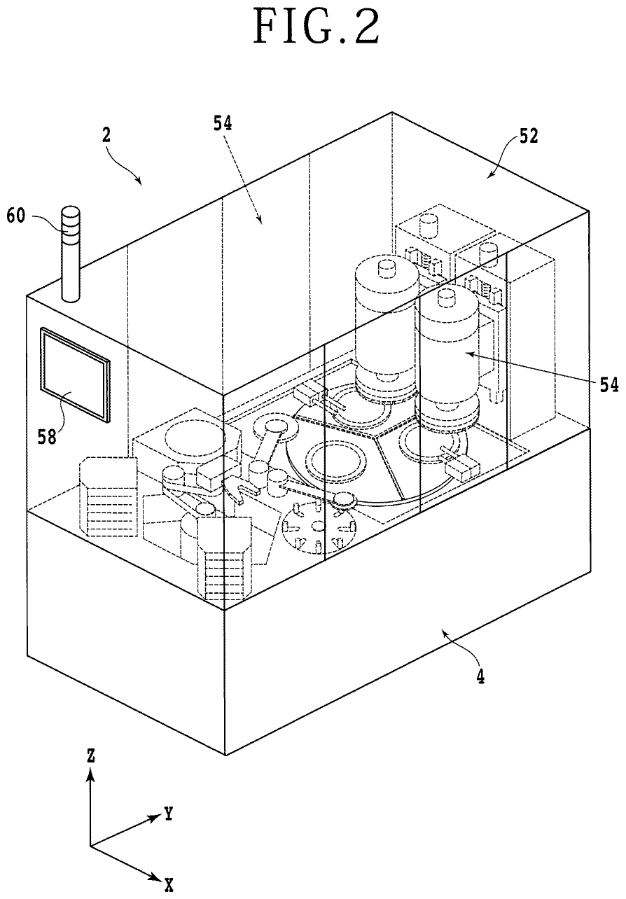

FIG. 2 is a perspective view schematically illustrating an exterior of the grinding apparatus 2. As illustrated in FIG. 2, an exterior cover 52 configured to have a hollow parallelepiped shape is provided on the upper surface side of the base 4. The exterior cover 52 covers such components as the chuck tables 18 and the grinding units 32 that configure the grinding apparatus 2.

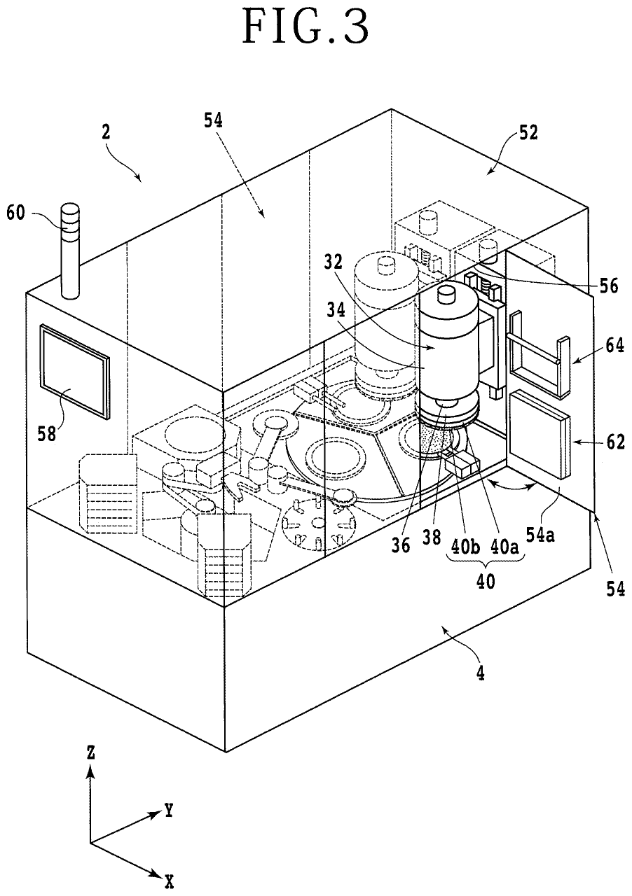

The exterior cover 52 includes a door 54. FIG. 3 is a perspective view schematically illustrating the grinding apparatus 2 in a state in which the door 54 is opened. As illustrated in FIG. 3, the door 54 is, for example, configured to have a plate shape that can cover a rectangular-shaped opening 56 provided in the exterior cover 52. The opening 56 is typically disposed at a position facing the grinding unit 32. In a state in which the door 54 is opened and the opening 56 is exposed, an operator can access the grinding unit 32 provided inside the door 54, through the opening 56 from the outside of the exterior cover 52.

On a front portion of the exterior cover 52, a touch screen (input/output device) 58 that serves as a user interface is arranged in such a manner as to allow operation from the outside of the exterior cover 52. Further, on an upper portion of the exterior cover 52, a pilot lamp 60 that emits light is arranged in such a manner as to be visually recognizable from the outside of the exterior cover 52. The touch screen 58 and the pilot lamp 60 are also connected to the controller 50.

For example, various conditions to be applied when the workpiece 11 is to be ground are input by the operator to the controller 50 via the touch screen 58. Further, for example, in a case where some kind of abnormality occurs in the grinding apparatus 2, the pilot lamp 60 emits light or blinks to notify the operator of that effect. Note that, instead of the touch screen 58 in which an input device and an output device (display device) are integrated, an input device such as a keyboard or a mouse and an output device (display device) such as a liquid crystal display may be employed.

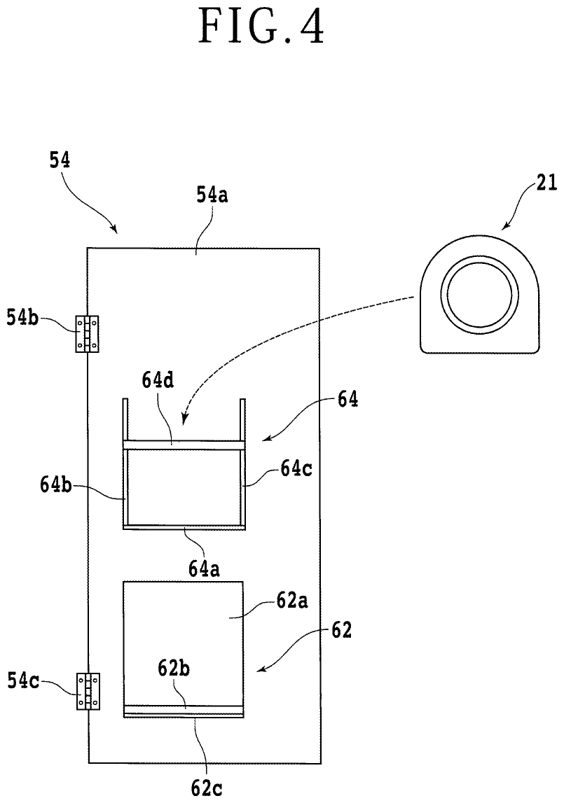

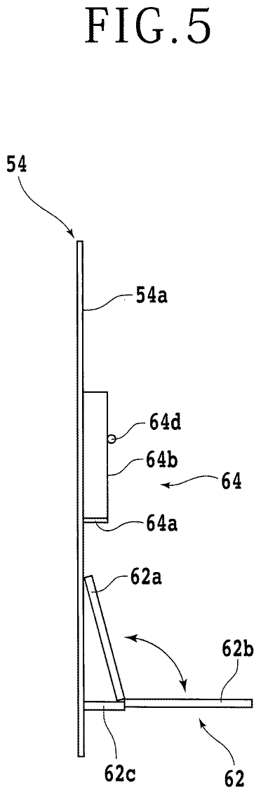

In the grinding apparatus 2 according to the present embodiment, as illustrated in FIG. 3, a foldable work bench 62 and a shelf 64 are provided on an inner surface 54a of the door 54 that faces the grinding unit 32 in a closed state in which the opening 56 is covered by the door 54. FIG. 4 is a front view of the door 54, the work bench 62, and the shelf 64 as viewed from the inside of the door 54. FIG. 5 is a side elevational view of the door 54, the work bench 62, and the shelf 64.

As illustrated in FIG. 4, on a side portion on one side of the door 54 configured to have a rectangular plate shape, hinges 54b and 54c are provided. The door 54 is coupled to the exterior cover 52 in an openable/closable manner via the hinges 54b and 54c. For example, when maintenance work is to be performed on the grinding apparatus 2, the door 54 is opened in such a manner that the opening 56 is exposed (open state). This allows the operator to access the grinding unit 32 provided inside the door 54, through the opening 56. When the maintenance work is ended, the door 54 is closed in such a manner as to cover the opening 56 (closed state).

The work bench 62 provided on the inner surface 54a of the door 54 has a first plate 62a that is configured to have a rectangular plate shape. For example, an upper side portion of the first plate 62a is fixed or coupled to the inner surface 54a of the door 54. To a lower side portion of the first plate 62a, a lower side portion of a second plate 62b that is configured to have a rectangular plate shape is coupled via a coupling member (not illustrated) such as a hinge. Thus, the second plate 62b rotates about the coupling member as the center of rotation.

As illustrated in FIG. 5, at a position corresponding to the lower side portion of the first plate 62a, the coupling member, and the lower side portion of the second plate 62b, there is provided a restricting member 62c that supports the first plate 62a and that restricts the angular range in which the second plate 62b can rotate. Note that, in a case where the angular range in which the second plate 62b can rotate is restricted by any other member or method, for example, the restricting member 62c may be omitted.

At the time when the work bench 62 configured as described above is used, for example, the second plate 62b rotates about the coupling member as the center of rotation, to adjust the height of the upper side portion of the second plate 62b to be substantially the same as the height of the lower side portion thereof. This allows the mounting surface of the second plate 62b facing upward to be substantially horizontal, and to be used to place various tools to be used for maintenance work, for example.

On the other hand, when the work bench 62 is to be housed, for example, the second plate 62b rotates about the coupling member as the center of rotation, to adjust the height of the upper side portion of the second plate 62b to be substantially the same as the height of the upper side portion of the first plate 62a, so that the work bench 62 is folded. Specifically, the second plate 62b is placed on top of the first plate 62a in such a manner that the placement surface of the second plate 62b comes into contact with one surface of the first plate 62a. This prevents the work bench 62 from interfering with the grinding unit 32 even in the closed state in which the door 54 is closed.

On a portion above the work bench 62 provided on the surface 54a, as illustrated in FIG. 4, there is provided the shelf 64 on which a case 21 capable of housing the grinding wheel 40 is placed. The shelf 64 includes, for example, a shelf board 64a that is configured to have a rectangular plate shape. The shelf board 64a has a flat placement surface on which the case 21 is placed, and is fixed to the surface 54a in such a manner that the placement surface is oriented upward.

To one end portion of the shelf board 64a, a lower end of a side plate 64b that is configured to have a rectangular plate shape and defines one end side of the housing range of the shelf 64 is connected. Similarly, to the other end portion of the shelf board 64a, a lower end of a side plate 64c that is configured to have a rectangular plate shape and defines the other end side of the housing range of the shelf 64 is connected. The side plates 64b and 64c are both fixed to the surface 54a.

Further, to the side plates 64b and 64c, a safety bar 64d for preventing the case 21 placed on the shelf board 64a from falling is fixed. Providing such a shelf 64 on the door 54 enables, for example, the work of replacing the grinding wheel 40 to be performed further efficiently. Note that the shelf 64 is also configured to have a size and a shape that prevent interference with the grinding unit 32, in the closed state in which the door 54 is closed.

As described above, the grinding apparatus 2 according to the present embodiment has the work bench 62 that is folded to prevent interference with the grinding unit 32, on the inner surface 54a of the door 54 that covers the opening 56 of the exterior cover 52. Accordingly, there is no need to carry in the work bench and make preparations or perform cleaning therefor, for example, every time maintenance work for the grinding apparatus 2 that is performed in a state in which the opening 56 is exposed is performed. Further, in the closed state in which the opening 56 is covered by the door 54, the work bench 62 is housed in the inner side of the exterior cover 52, so that there is also no need to reserve a place for storing a work bench separately from the place where the grinding apparatus 2 is installed. This increases the efficiency of the maintenance work for the grinding apparatus 2 and is also advantageous in terms of space-saving.

Note that the present invention can be implemented with various modifications applied thereto without being limited to the description made in the abovementioned embodiment. For example, the number, manner of arrangement, and the like of the door 54 to be provided in the grinding apparatus 2 are not limited to the abovementioned forms. The number of doors 54 to be provided in the grinding apparatus 2 may be one or two or more. Further, in a case where a plurality of doors 54 are provided, the work bench 62 and the shelf 64 may be provided on every door 54 or only on some of the doors 54. Further, providing at least the work bench 62 on the door 54 is sufficient; the shelf 64 may not be provided on the door 54.

Further, structures, methods, and the like according to the embodiment and modifications can appropriately be changed and implemented within the scope of the object of the present invention.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A grinding apparatus used at a time of grinding a workpiece, the grinding apparatus comprising:
a chuck table that has a holding surface for holding the workpiece;
a grinding unit that has a spindle to which a grinding wheel in which a plurality of grindstones are arrayed in an annular shape is mounted; and
an exterior cover that includes an opening facing the grinding unit and a door capable of covering the opening and that covers both the chuck table and the grinding unit, wherein,
on an inner surface of the door that faces the grinding unit in a closed state in which the opening is covered by the door, a work bench that is folded to prevent interference with the grinding unit in the closed state is provided.

2. The grinding apparatus according to claim 1, wherein, on the inner surface of the door, a shelf on which a case that houses the grinding wheel is placed is further provided.
